(19) United States
(12) Patent Application Publication
(10) Pub. No.: US 2023/0322060 A1
(43) Pub. Date: Oct. 12, 2023

(54) SUNROOF STRUCTURE OF VEHICLE

(71) Applicant: Fei WEI, Taichung City (TW)

(72) Inventor: Fei WEI, Taichung City (TW)

(21) Appl. No.: 18/126,088

(22) Filed: Mar. 24, 2023

(30) Foreign Application Priority Data
Apr. 8, 2022 (TW) 111203574

(51) Int. Cl. B60J 7/16; E05F 15/00

(52) U.S. Cl. CPC B60J 7/1642; E05F 15/00; E05Y 2201/43; E05Y 2201/624; E05Y 2201/716; E05Y 2201/712; E05Y 2600/452; E05Y 2800/10; E05Y 2900/542

(57) ABSTRACT

A sunroof structure of a vehicle includes at least one first mount for being mounted to a vehicle body of the vehicle, a window panel for being disposed to a hollow portion of the vehicle and having a main body and second and third mounts disposed on a bottom side of the main body, a transmission member including first and second rotational shafts rotatably disposed with the first and second mounts respectively and at least one crank connected with the first and second rotational shafts, and a link pivotally connected between the third mount and a pivot mount of the vehicle body. As a result, the window panel is drivenable to close or open the hollow portion. The sunroof structure greatly increases the open area of the hollow portion, and provides the side shielding function for the vehicle when the window panel is opened.

### BACKGROUND OF THE INVENTION

### 1. Field of the Invention

The present invention relates generally to vehicles and more particularly, to a sunroof structure of a vehicle.

### 2. Description of the Related Art

The sunroof of a conventional vehicle can only be opened in an inclined manner, or can only move forward or backward after it is opened. In order to prevent the sunroof from protruding beyond the vehicle body after it is opened, the area of the hollow portion (window) of the roof of the vehicle will be limited in a certain extent. Theoretically, the maximum window area cannot exceed half of the roof area. Because the sunroof driving mechanism and linkage mechanism also need space for installation, the area of the conventional sunroof having a dimension reaching two-thirds of the roof area will be the maximum extent.

In another aspect, in addition to the need to open the sunroof to enjoy the scenery, the camper also has the need for sunshade and rain protection on the side thereof. Therefore, how to use the most simplified design to fulfill various needs has become an issue to be improved by the industry.

### SUMMARY OF THE INVENTION

The present invention has been accomplished in view of the above-noted circumstances. It is an objective of the present invention to provide a sunroof structure of a vehicle, which can greatly increase the area of the window opening.

It is another objective of the present invention to provide a sunroof structure of a vehicle, which can provide a side shielding function when it is opened.

It is still another objective of the present invention to provide a sunroof structure of a vehicle, which has a simple structural design and low manufacturing cost, saves space required for installation, and has great market potential.

To attain the above objectives, the present invention provides a sunroof structure adapted for being installed to a vehicle comprising a vehicle body and a pivot mount. The vehicle body comprises a roof plate having a hollow portion. The sunroof structure comprises at least one first mount, a window panel, a transmission member, and a link. The first mount is adapted for being mounted to an inside of the vehicle body. The window panel is adapted for being disposed to the hollow portion and comprises a main body, at least one second mount disposed on a bottom side of the main body, and a third mount disposed on the bottom side of the main body. The transmission member comprises a first rotational shaft rotatably disposed with the first mount, a second rotational shaft rotatably disposed with the second mount, and at least one crank connected between the first and second rotational shafts. The link includes a first end pivotally connected with the third mount, and a second end adapted for being pivotally connected with the pivot mount of the vehicle body. As a result, the window panel is drivenable to close or open the hollow portion. With the aforesaid structural features, the area of the window opening can be greatly increased, and a side shielding function can be provided when the window panel is driven to open the hollow portion. Further, the sunroof structure has a simple structural design to result in low manufacturing cost, and saves the space required for installation, thereby providing great market potential.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view showing a sunroof structure of a vehicle according to an embodiment of the present invention;

FIG. 2 is a bottom perspective view of the sunroof structure of the vehicle according to the embodiment of the present invention;

FIG. 3 is a lateral side view showing a part of the sunroof structure of the vehicle according to the embodiment of the present; and

FIGS. 4 and 5 are schematic views showing the motions of the sunroof structure in various opened states.

### DETAILED DESCRIPTION OF THE INVENTION

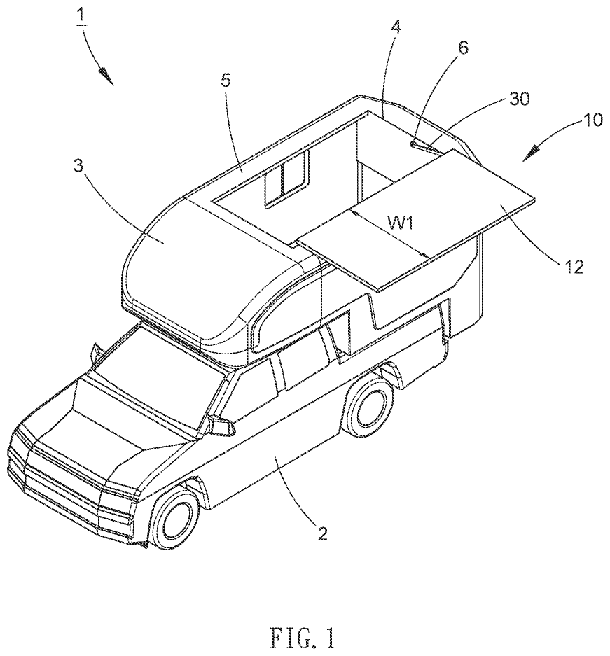

The structure and technical features of the present invention will be detailedly described hereunder by an embodiment and accompany drawings. As shown in FIG. 1, a sunroof structure 10 provided in accordance with an embodiment of the present invention is provided in a vehicle 1. The vehicle 1 is a truck camper composed of a camper housing installed on a pickup truck 2. However, the vehicle 1 can also be of other types. The vehicle 1 includes a vehicle body 3 having a roof plate 5 with a rectangular hollow portion 4 thereon, and a pivot mount 6 arranged on the vehicle body 3 and located beside the roof plate 5. The sunroof structure 10 is composed of a window panel 12, two first mounts 20, a transmission member 22, a link 30, and a drive device 34.

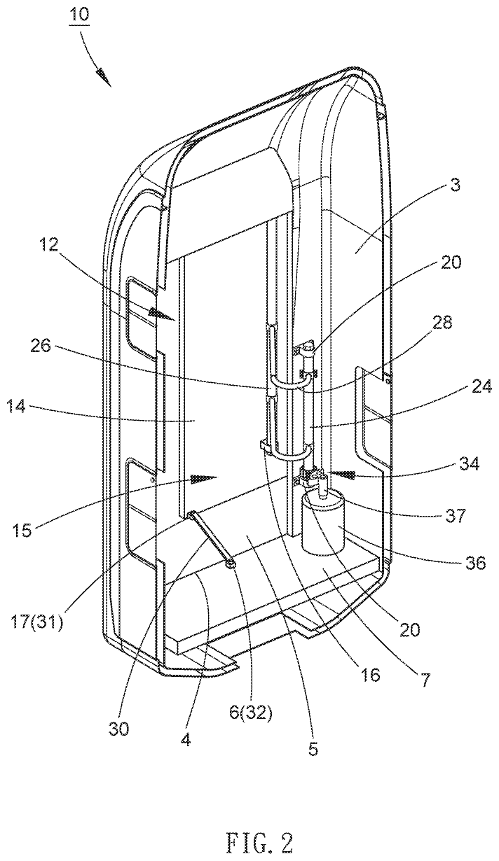

FIG. 2 is a perspective view of the sunroof structure 10 viewed from the inside of the vehicle. The window panel 12 is used to be disposed on the hollow portion 4 and is moved to a half-opened state. The window panel 12 has a rectangular main body 14, two second mounts 16 located on the bottom side 15 of the main body 14 (located on the right side of FIG. 2), and a third mount 17 located on the bottom side 15 of the main body 14 (located on the left side of FIG. 2). The dimension of the main body 14 corresponds in size to the dimension of the hollow portion 4. The two second mounts 16 are spacedly arranged at an interval along the front and rear direction of the vehicle body 3.

The two first mounts 20 are used to be disposed on an inside of the vehicle body 3, and located at places close to the hollow portion 4 but not limited to the parts of the roof plate 5 or the vehicle body 3. The two first mounts 20 are also spacedly arranged at an interval along the front and rear direction of the vehicle body 3.

The transmission member 22 includes a first rotational shaft 24 rotatably disposed with the two first mounts 20, a second rotational shaft 26 rotatably disposed with the second mounts 16, and two cranks 28 connected between the first and second rotational shafts 24 and 26. The number of the crank 28 is not limited to the one shown in this embodiment. One or more cranks 28 can be used. One or more reinforcing rods may be further provided between the two cranks 28 to enhance the structural strength.

The link 30 has a first end 31 pivotally connected with the third mount 17, and a second end 32 adapted for being pivotally connected with the pivot mount 6 of the vehicle body 3. In this embodiment, the link 30 is a straight rod having a length L1 greater than a half of the width W1 of the window panel 12. In another embodiment of the present invention, the length L1 of the link 30 is exactly equal to a half of the width W1 of the window panel 12.

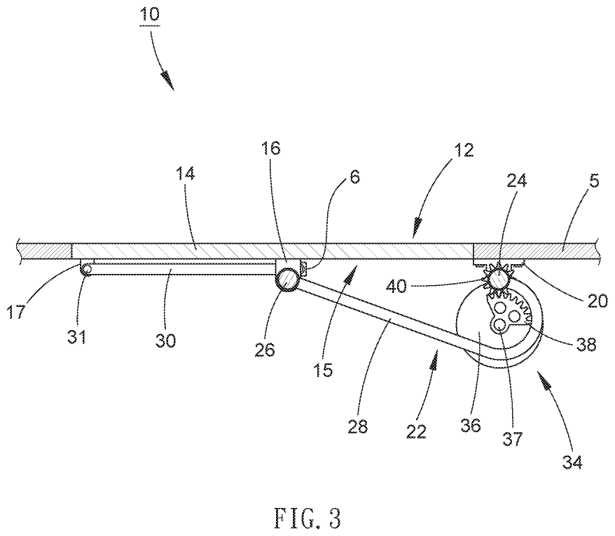

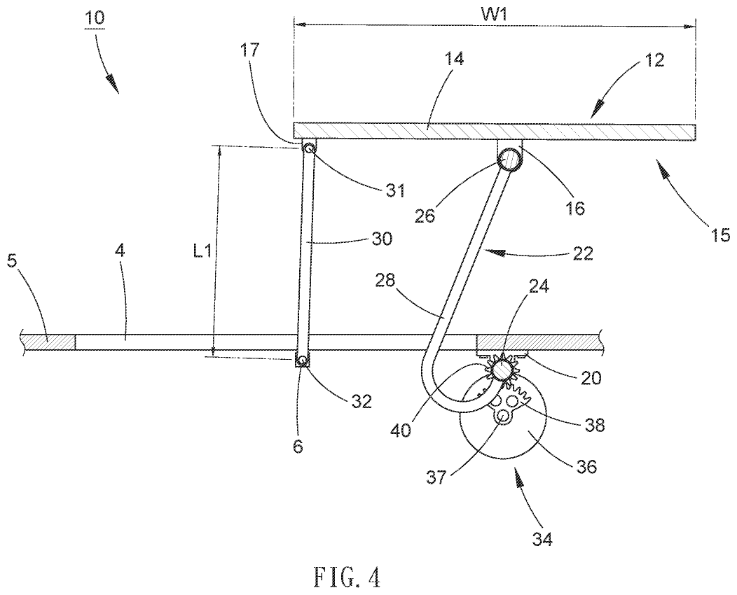

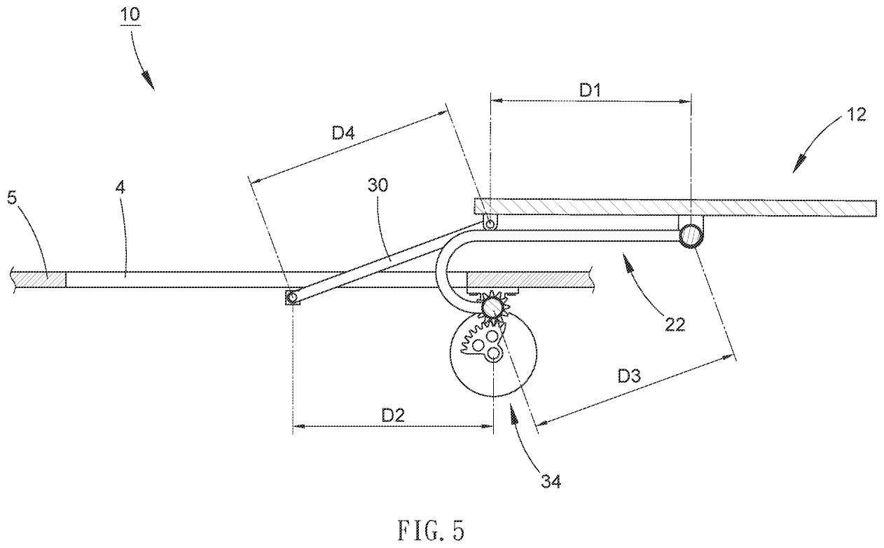

The drive device 34 is used to be disposed on the inside of the vehicle body 3 and can drive the first rotational shaft 24 to rotate. The drive device 34 may be an electric or pneumatic motor, electric cylinder, pneumatic cylinder, or hydraulic cylinder. In this embodiment, the drive device 34 includes a motor 36 for being disposed on a side wall 7 of the vehicle body 3, a driving gear 38 coaxially connected with a drive shaft 37 of the motor 36, and a driven gear 40 coaxially connected with the first rotational shaft 24 of the transmission member 22 and engaged with the driving gear 38. As such, as shown in FIGS. 3-5, when the drive shaft 37 of the motor 36 rotates, the driving force will be transmitted from the driving gear 38, the driven gear 40 to the rotational shaft 24, such that the rotational shaft 24 can drive the transmission member 22 to rotate clockwise, thereby allowing the window panel 12 to move from a closed position where the window panel 12 fully blocks the hollow portion 4, as shown in FIG. 3, to a fully opened position where the hollow portion 4 is not blocked or overlapped by the window panel 12, as shown in FIG. 5, so that people in the vehicle can freely see the complete sky through the hollow portion 4. In another embodiment, the motor 36 can be arranged on other parts of the vehicle body 3 and not limited to the side wall 7.

In another aspect, because a special design that a distance D1 between a pivotal axis of the second mounts 16 and a pivotal axis of the third mount 17 (equivalent to the distance between the second rotational shaft 26 and the first end 31 of the link 30 in the viewing angle of FIG. 5) is approximately equal to a distance D2 between a pivotal axis of the pivot mount 6 and a pivotal axis of the first mounts 20 (equivalent to the distance between the first rotational shaft 24 and the second end 32 of the link 30 in the viewing angle of FIG. 5), and a distance D3 between the pivotal axis of the second mounts 16 and the pivotal axis of the first mounts 20 is approximately equal to a distance D4 between the pivotal axis of the third mount 17 and the pivotal axis of the pivot mount 6, in the moving path where the window panel 12 is driven by the drive device 34 to move, the window panel 12 will be flush with or parallel to the roof plate 5. Furthermore, because the length L1 of the link 30 is greater than or equal to a half of the width W1 of the window panel 12, the window plate 12 will not be overlapped over the hollow portion 4 when the window panel 12 is moved to the fully opened position as shown in FIG. 5. Moreover, when the window panel 12 is moved to the fully opened position, the window panel 12 is located at a left side (or a right side) of the vehicle body 3 to shade the left side (or the right side) of the vehicle. In another embodiment of the present invention, the above-mentioned various distances, length or width may be changed in accordance with actual need.

With the above-disclosed structural features, the sunroof structure 10 of the present invention can greatly increase the area of the window opening, which not only helps air convection and lowers the temperature inside the vehicle, but also saves the cost of installing range hoods for cooking. Further, the sunroof structure 10 can provide a side shielding function to the vehicle when it is opened. Moreover, the sunroof structure 10 has a simple structural design to result in low manufacturing cost, and saves the space required for installation, thereby providing great market potential and thus achieving the objectives of the present invention.

Based on the above-mentioned structural design, various modifications to the sunroof structure 10 provided by the present invention may be made. For example, one second mount 16 and one first mount 20 may be sufficient for accomplishing the present invention. That is, one or more first mounts 20 or second mounts 16 may be used in the present invention. For the drive device 34, any conventional driving apparatus or actuator may be used as long as it can drive the transmission member 22 to rotate. Alternatively, the drive device 34 may be omitted, such that the sunroof structure 10 may be driven manually. Such variations are not to be regarded as a departure from the spirit and scope of the invention, and all such modifications as would be obvious to one skilled in the art are intended to be included within the scope of the following claims.

What is claimed is:

1. A sunroof structure of a vehicle, the vehicle comprising a vehicle body and a pivot mount, the vehicle body comprising a roof plate having a hollow portion, the sunroof structure comprising:
at least one first mount adapted for being mounted to an inside of the vehicle body;
a window panel adapted for being disposed to the hollow portion and comprising a main body, at least one second mount disposed on a bottom side of the main body, and a third mount disposed on the bottom side of the main body:
a transmission member comprising a first rotational shaft rotatably disposed with the first mount, a second rotational shaft rotatably disposed with the second mount, and at least one crank connected between the first rotational shaft and the second rotational shaft; and
a link having a first end pivotally connected with the third mount, and a second end adapted for being pivotally connected with the pivot mount of the vehicle body;
whereby the window panel is drivenable to close or open the hollow portion.

2. The sunroof structure of the vehicle as claimed in claim 1, wherein the window panel is driven to move parallelly relative to the roof plate.

3. The sunroof structure of the vehicle as claimed in claim 1, wherein a distance between a pivotal axis of the second mount and a pivotal axis of the third mount is substantially equal to a distance between a pivotal axis of the pivot mount and a pivotal axis of the first mount.

4. The sunroof structure of the vehicle as claimed in claim 3, wherein a distance between the pivotal axis of the second mount and the pivotal axis of the first mount is substantially equal to a distance between the pivotal axis of the pivot mount and the pivotal axis of the third mount.

5. The sunroof structure of the vehicle as claimed in claim 1, wherein a distance between a pivotal axis of the second mount and a pivotal axis of the first mount is substantially equal to a distance between a pivotal axis of the pivot mount and a pivotal axis of the third mount.

6. The sunroof structure of the vehicle as claimed in claim 1, wherein a length of the link is greater than or equal to a half of a width of the window panel.

7. The sunroof structure of the vehicle as claimed in claim 1, wherein when the window panel is moved to an opened position, the window panel is located at a left side or a right side of the vehicle body to shade the left or right side of the vehicle body.

8. The sunroof structure of the vehicle as claimed in claim 1, wherein the window panel is driven to move to an opened position where the window panel is not overlapped over the hollow portion.

9. The sunroof structure of the vehicle as claimed in claim 1, wherein the sunroof structure further comprises a drive device adapted for being mounted on the inside of the vehicle body; the drive device drives the first rotational shaft to rotate, such that the window panel is driven by the drive device to close or open the hollow portion.

10. The sunroof structure of the vehicle as claimed in claim 9, wherein the driven device comprises a motor adapted for being mounted to the vehicle body, a driving gear connected with a drive shaft of the motor, and a driven gear connected with the first rotational shaft of the transmission member and engaged with the driving gear.

11. The sunroof structure of the vehicle as claimed in claim 9, wherein the window panel is driven by the drive device to move parallelly relative to the roof plate.

12. The sunroof structure of the vehicle as claimed in claim 9, wherein a distance between a pivotal axis of the second mount and a pivotal axis of the third mount is substantially equal to a distance between a pivotal axis of the pivot mount and a pivotal axis of the first mount.

13. The sunroof structure of the vehicle as claimed in claim 12, wherein a distance between the pivotal axis of the second mount and the pivotal axis of the first mount is substantially equal to a distance between the pivotal axis of the pivot mount and the pivotal axis of the third mount.

14. The sunroof structure of the vehicle as claimed in claim 9, wherein a distance between a pivotal axis of the second mount and a pivotal axis of the first mount is substantially equal to a distance between a pivotal axis of the pivot mount and a pivotal axis of the third mount.

15. The sunroof structure of the vehicle as claimed in claim 9, wherein a length of the link is greater than or equal to a half of a width of the window panel.

16. The sunroof structure of the vehicle as claimed in claim 9, wherein when the window panel is moved to an opened position, the window panel is located at a left side or a right side of the vehicle body to shade the left or right side of the vehicle body.

17. The sunroof structure of the vehicle as claimed in claim 9, wherein the window panel is driven by the drive device to move to an opened position where the window panel is not overlapped over the hollow portion.
